(19) United States
(12) Patent Application Publication
(10) Pub. No.: US 2017/0059913 A1
(43) Pub. Date: Mar. 2, 2017

(54) OPTICAL COMPOSITE LAYER STRUCTURE

(71) Applicant: NANOBIT TECH. CO., LTD., Taoyuan County (TW)

(72) Inventors: Fu-Tien KU, Taoyuan County (TW); Shiou-Ming LIU, Taoyuan County (TW); Ding-Kuo DING, Taoyuan County (TW); Yu-Yang CHANG, Taoyuan County (TW); Te-Liang YU, Taoyuan County (TW)

(21) Appl. No.: 14/965,223

(22) Filed: Dec. 10, 2015

(30) Foreign Application Priority Data
Aug. 28, 2015 (TW) 104213986

(51) Int. Cl. G02F 1/1333; G02F 1/1334

(52) U.S. Cl. CPC G02F 1/13338; G02F 1/1334; G02F 1/133305

(57) ABSTRACT

The invention provides an optical composite layer structure. The optical composite layer structure comprises a polymer dispersed liquid crystal (PDLC) composite layer, a first optical adhesive layer and a touch sensitive composite layer, wherein the touch sensitive composite layer is attached to the PDLC composite layer by the first optical adhesive layer. The optical composite layer structure may be attached with a fixed light transmission substrate at a side surface or two side surfaces thereof. Each the PDLC composite layer and the touch sensitive composite layer may be connected electrically with external control units by soft cables. A touch sensitive operation of the touch sensitive composite layer is used to provide a signal instruction to the control unit. Accordingly, the corresponding PDLC circuit may drive the corresponding regions of the PDLC composite layer to conduct the change of light transmission of local region.

### BACKGROUND OF THE INVENTION

Field of the Invention

The present invention relates to an optical composite layer structure, more particularly to a composite layer structure in combination with a polymer dispersed liquid crystal layer and a touch sensitive transparent conductive layer.

Description of the Related Art

A traditional polymer dispersed liquid crystal (PDLC) is formed by using anisotropic liquid crystal droplets distributing in polymers uniformly, typically anisotropic liquid crystal droplets with positive dielectric constant distributing in polymers uniformly that have no a specific direction in a normal state, and the light transmitted through the anisotropic liquid crystal droplets fails to match with the refractive index of the polymers so that incident light may scatter seriously due to many interfaces existing and light transmission rate is low. If a specific electric field is provided, the anisotropic liquid crystal droplets with positive dielectric constant may be arranged forward along the electric field, and the light transmitted through the anisotropic liquid crystal droplets with positive dielectric constant may match with the refractive index of the polymers so that the most incident light may transmit through forward and the light transmission rate is increased. Smart windows are formed by packaging PDLC in transparent substrates such as conductive glasses and switching the electric field on or off to control the change of transparency of the transparent substrates. Smart windows can dynamically change the tinting of glass to control the amount of light/heat that enters a building. They can also be used to create on-demand private spaces for offices. Recently, soft conductive transparent resins have been used to package PDLC instead of the conductive glasses by the advancing process and material so that the process can be simplified greatly and the application of the related products can be enhanced greatly. For example, the structure of soft conductive transparent resins packaging PDLC in combination with transparent adhesive technologies can be attached on glass of buildings, windows of cars, refrigerators or projection walls for increasing use of applications.

However, there is a demand of design and improvement for use of convenience to the structure of conductive transparent substrates packaging PDLC, especially the corresponding light transmission or image display.

### SUMMARY OF THE INVENTION

It is an object of the present invention to disclose an optical composite layer structure. The optical composite layer structure is mainly formed by a polymer dispersed liquid crystal (PDLC) composite layer, a first optical adhesive layer and a touch sensitive composite layer, wherein the touch sensitive composite layer is attached to the PDLC composite layer by the first optical adhesive layer. Further, the optical composite layer structure may be attached with an external element, e.g., a fixed light transmission substrate or glass at a side surface or two side surfaces thereof. The fixed light transmission substrate may be a glass curtain wall of building, glass window of building, showcase, window of refrigerator, windshield of car, etc.

It is another object of the present invention to disclose an optical composite layer structure. The first and second transparent conductive layers of the touch sensitive composite layer and the upper and lower transparent conductive layers of the PDLC composite layer may be etched to form circuit layers.

It is still another object of the present invention to disclose an optical composite layer structure. The first and second transparent conductive layers of the touch sensitive composite layer and the upper and lower transparent conductive layers of the PDLC composite layer may be may be connected electrically with external control units by soft cables. A touch sensitive operation of the touch sensitive composite layer is used to provide a signal instruction to the control unit. Accordingly, the corresponding PDLC circuit may drive the corresponding regions of the PDLC composite layer to conduct the change of light transmission of a specific region of the PDLC composite layer.

Accordingly, the present invention provides an optical composite layer structure comprising: a polymer dispersed liquid crystal (PDLC) composite layer, a first optical adhesive layer and a touch sensitive composite layer. The PDLC composite layer comprises an upper transparent substrate, a lower transparent substrate, an upper transparent conductive layer, a lower transparent conductive layer and a PDLC layer. An upper curing layer is formed on a side surface of the upper transparent substrate, and a lower curing layer is formed on a side surface of the lower transparent substrate. The upper transparent conductive layer is provided on a side surface of the upper curing layer, and the lower transparent conductive layer is provided on a side surface of the lower curing layer. The PDLC layer is provided between the upper transparent conductive layer and the lower transparent conductive layer. The first optical adhesive layer is provided on another side surface of the upper transparent substrate. The touch sensitive composite layer is provided on a side surface of the first optical adhesive layer, and the touch sensitive composite layer at least includes a first touch sensitive composite layer, and the first touch sensitive composite layer comprises a first transparent substrate having a first curing layer on a side surface thereof; and a first transparent conductive layer.

In an aspect of the present invention, the touch sensitive composite layer further comprises a second optical adhesive layer provided on a side surface of the first transparent conductive layer, and a second touch sensitive composite layer provided on a side surface of the second optical adhesive layer, wherein the second touch sensitive composite layer comprises: a second transparent substrate having a second curing layer on a side surface of the second transparent substrate; and a second transparent conductive layer.

In an aspect of the present invention, an optical cover layer is provided on a side surface of the second transparent conductive layer. In addition, the upper and lower transparent substrates and the first and second transparent substrates are made of light transmission resins or light transmission glass substrate. Also, the upper and lower transparent conductive layers and the first and second transparent conductive layers are made of metal or metallic oxides, wherein the metallic oxides are silver oxide, nano-silver oxide or indium tin oxide (ITO).

In another aspect of the present invention, the upper and lower transparent conductive layers and the first and second transparent conductive layers are made of organic conductive materials, wherein the organic conductive materials are carbon nanotube or poly-3,4-ethylenedioxythiophene (PEDOT).

In an aspect of the present invention, the upper and lower transparent conductive layers and the first and second transparent conductive layers have a thickness in a range of 5 nm-50 um. Also, the PDLC layer has a thickness in a range of 1 um-100 um.

In an aspect of the present invention, the optical composite layer structure further comprises a fixed light transmission substrate that is attached with a third optical adhesive layer and a four optical adhesive layer on two side surfaces thereof, and the third optical adhesive layer and the four optical adhesive layer are used for attaching with the PDLC composite layer and the touch sensitive composite layer respectively. Also, the fixed light transmission substrate is glass window or made of light transmission resins.

In an aspect of the present invention, the optical composite layer structure further comprises a fifth optical adhesive layer that is provided on another side surface of the upper transparent substrate of the PDLC composite layer, and the fixed light transmission substrate provided on a side surface of the fifth optical adhesive layer.

In an aspect of the present invention, the optical composite layer structure further comprises soft cables for connecting electrically the upper and lower transparent conductive layers and the first and second transparent conductive layers to a control unit. Accordingly, the corresponding PDLC circuit may drive the corresponding regions of the PDLC composite layer to conduct the change of light transmission of local region.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 shows a side view of an optical composite layer structure of a first embodiment according to the present invention.

FIG. 2 shows a side view of an optical composite layer structure of a second embodiment according to the present invention.

FIG. 3 shows a side view of an optical composite layer structure of a third embodiment according to the present invention.

FIG. 4 shows a side view of an optical composite layer structure of a fourth embodiment according to the present invention, wherein the optical composite layer structure connects with an external control unit.

### DETAILED DESCRIPTION OF THE INVENTION

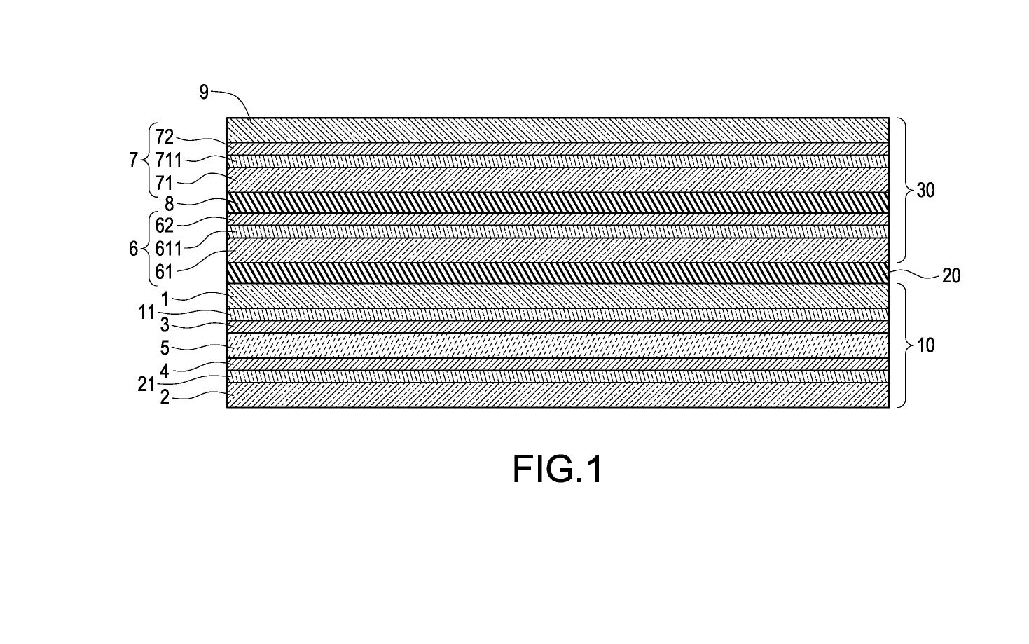

FIG. 1 shows a side view of an optical composite layer structure of a first embodiment according to the present invention. According to FIG. 1, in the first embodiment, the optical composite layer structure comprises a polymer dispersed liquid crystal (PDLC) composite layer 10, a first optical adhesive layer 20 and a touch sensitive composite layer 30.

The PDLC composite layer 10 comprises an upper transparent substrate 1, a lower transparent substrate 2, an upper transparent conductive layer 3, a lower transparent conductive layer 4 and a PDLC layer 5. The upper transparent substrate 1 and the lower transparent substrate 2 are light transmission resin substrate or light transmission glass substrate. The light transmission resin is polyethylene terephthalate (PET), polyethylene (PE), polyimide (PI), polyamide (PA), polyurethanes (PU) or acrylic resin, etc. The upper transparent substrate 1 has a thickness in a range of 10 um-10 mm, and preferably, in a range of 20 um-500 um. The lower transparent substrate 2 has a thickness in a range of 10 um-10 mm, and preferably, in a range of 20 um-500 um.

Also, an upper curing layer 11 is formed on a side surface of the upper transparent substrate 1 by a curing treatment. A lower curing layer 12 is formed on a side surface of the lower transparent substrate 2 by a curing treatment. The material used in the upper curing layer 11 and the lower curing layer 12 is selected from the group consisting of acrylic resin, epoxy and silica, wherein the material has the refractive index of 1.1-3.5. The upper curing layer 11 has a thickness in a range of 500 nm-50 um, and preferably, in a range of 1 um-5 um. The lower curing layer 12 has a thickness in a range of 500 nm-50 um, and preferably, in a range of 1 um-5 um.

In addition, the upper transparent conductive layer 3 is provided on a side surface of the upper curing layer 11. The lower transparent conductive layer 4 is provided on a side surface of the lower curing layer 21. The upper transparent conductive layer 3 is a circuit or conductive block (not shown) formed by dry etching or wet etching with inorganic conductive material of metal or metallic oxides such as silver oxide, nano-silver oxide or indium tin oxide (ITO), or organic conductive material such as carbon nanotube or poly-3,4-ethylenedioxythiophene (PEDOT) that has the light transmission rate of 70%-95%. Similarly, the lower transparent conductive layer 4 is a circuit or conductive block (not shown) formed by dry etching or wet etching with inorganic conductive material of metallic oxides such as silver oxide, nano-silver oxide or indium tin oxide (ITO), or organic conductive material such as carbon nanotube or poly-3,4-ethylenedioxythiophene (PEDOT) that has the light transmission rate of 70%-95%. The upper transparent conductive layer 3 has a thickness in a range of 5 nm-50 um, and preferably, in a range of 100 nm-10 um. The lower transparent conductive layer 4 has a thickness in a range of 5 nm-50 um, and preferably, in a range of 100 nm-10 um.

The PDLC layer 5 is provided between the upper transparent conductive layer 3 and the lower transparent conductive layer 4. The PDLC layer 5 has a thickness in a range of 1 um-100 um. The PDLC layer 5 is formed of PDLC resins as a main element and mixing with a material selected from the group consisting of UV resins, thermal setting resins and silica, wherein PDLC resins have the light transmission rate of 50%-80% and refractive index of 1.5-5.5 after electric conduction.

The first optical adhesive layer 20 is provided on another side surface of the upper transparent substrate 1. The first optical adhesive layer 20 has a thickness in a range of 1 um-1000 um. The first optical adhesive layer 20 is an optical adhesive sheet with refractive index in a range of 1.1-3.5.

The touch sensitive composite layer 30 is provided on a side surface of the first optical adhesive layer 20. The touch sensitive composite layer 30 at least includes a first touch sensitive composite layer 6, a second touch sensitive composite layer 7, a second optical adhesive layer 8 and an optical cover layer 9. The first touch sensitive composite layer 6 comprises a first transparent substrate 61, and the second touch sensitive composite layer 7 comprises a second transparent substrate 71. Also, a first curing layer 611 is formed on a side surface of the first transparent substrate 61, and a second curing layer 711 is formed on a side surface of the second transparent substrate 71. The material used in the first curing layer 611 and the second curing layer 711 is selected from the group consisting of acrylic resin, epoxy and silica, wherein the material has the refractive index of 1.1-3.5. The first curing layer 611 has a thickness in a range of 500 nm-50 um, and preferably, in a range of 1 um-5 um. The second curing layer 711 has a thickness in a range of 500 nm-50 um, and preferably, in a range of 1 um-5 um. In addition, a first transparent conductive layer 62 is provided on a side surface of the first curing layer 611, and a second transparent conductive layer 72 is provided on a side surface of the second curing layer 711. Both the first and second transparent conductive layers 62, 72 are circuits or conductive blocks (not shown) formed by dry etching or wet etching with inorganic conductive material of metal or metallic oxides such as silver oxide, nano-silver oxide or indium tin oxide (ITO), or organic conductive material such as carbon nanotube or poly-3,4-ethylenedioxythiophene (PEDOT) that has the light transmission rate of 70%-95%. Both the first and second transparent conductive layers 62, 72 have a thickness in a range of 5 nm-50 um, and preferably, in a range of 100 nm-10 um. The second optical adhesive layer 8 is provided between a side surface of the first transparent conductive layer 62 and a side surface of the second transparent substrate 71. The optical cover layer 9 is provided on a side surface of the second transparent conductive layer 72.

The optical composite layer structure disclosed in the above-mentioned embodiment is mainly formed by a polymer dispersed liquid crystal (PDLC) composite layer 10, a first optical adhesive layer 20 and a touch sensitive composite layer 30, wherein the touch sensitive composite layer 30 is attached to the PDLC composite layer 10 by the first optical adhesive layer 20. The optical composite layer structure may be attached with external elements, e.g., a light transmission substrate (not shown) or glass (not shown) at a side surface or two side surfaces thereof. The light transmission substrate may be a glass curtain wall of building, glass window of building, showcase, window of refrigerator, windshield of car, etc.

Further, the upper and lower transparent conductive layers 3, 4 and the first and second transparent conductive layers 62, 72 are connected with an external control unit by a soft cable. A user can use a touch sensitive operation of the touch sensitive composite layer 30 to conduct the change of light transmission of a specific region of the PDLC composite layer 10.

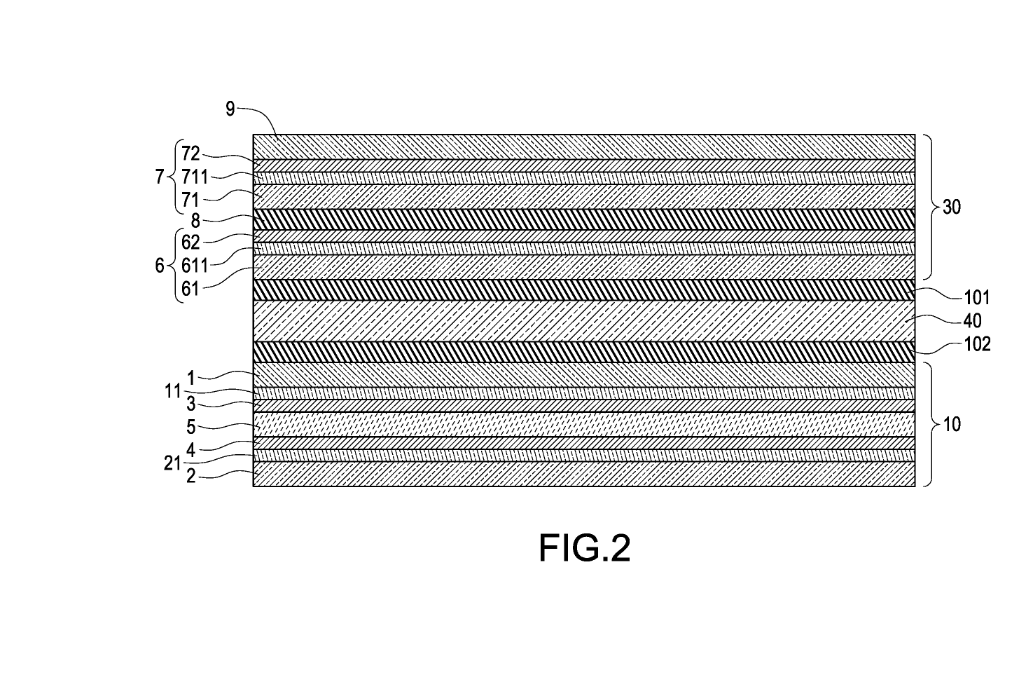

FIG. 2 shows a side view of an optical composite layer structure of a second embodiment according to the present invention. According to FIG. 2, in the embodiment, the optical composite layer structure may be disassembled, and combined with a fixed light transmission substrate 40, e.g., glass window or light transmission resins. The fixed light transmission substrate 40 is attached with a third optical adhesive layer 101 and a four optical adhesive layer 102 on two side surfaces thereof. The third and four optical adhesive layers 101, 102 are used for attaching with the PDLC composite layer 10 and the touch sensitive composite layer 30 respectively. The upper and lower transparent conductive layers 3, 4 of the PDLC composite layer 10 and the first and second transparent conductive layers 62, 72 of the touch sensitive composite layer 30 are patterned and corresponded mutually. Each the PDLC composite layer 10 and the touch sensitive composite layer 30 may be connected electrically with external control units (not shown) by soft cables. A user can use a capacitive touch sensitive operation of the touch sensitive composite layer 30 to provide a signal instruction to the control unit. Accordingly, the corresponding PDLC circuit may drive the corresponding regions of the PDLC composite layer 10 to conduct the change of light transmission of local region, for example hand writing board, the gray level change of light transmission of PDLC and light transmission control of local region of PDLC, etc. In FIG. 2, the fixed light transmission substrate 40 has a thickness of about 500 um-50 mm.

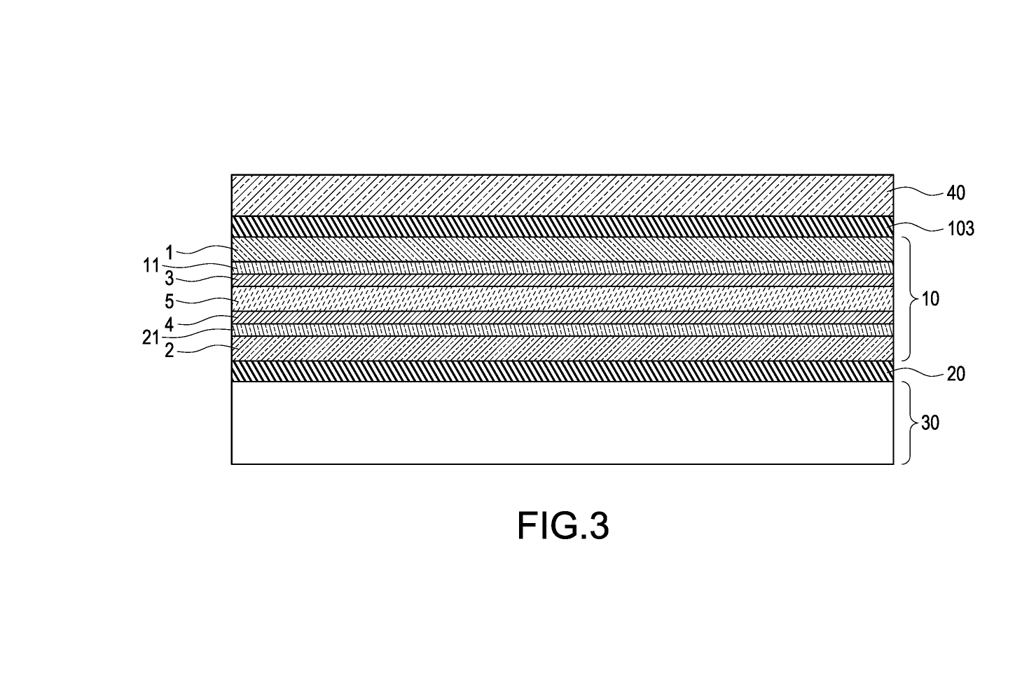

FIG. 3 shows a side view of an optical composite layer structure of a third embodiment according to the present invention. According to FIG. 3, in the embodiment, the fixed light transmission substrate 40 is attached to the PDLC composite layer 10 on another side surface of the upper transparent substrate 1 with a fifth optical adhesive layer 103. The upper and lower transparent conductive layers 3, 4 of the PDLC composite layer 10 and the first and second transparent conductive layers 62, 72 of the touch sensitive composite layer 30 are patterned and corresponded mutually. Each the PDLC composite layer 10 and the touch sensitive composite layer 30 use soft cables to connect electrically with external control units (not shown). A user can use a capacitive touch sensitive operation of the touch sensitive composite layer 30 to provide a signal instruction to the control unit. Accordingly, the corresponding PDLC circuit may drive the corresponding regions of the PDLC composite layer 10 to conduct the change of light transmission of local region, for example hand writing board, the gray level change of light transmission of PDLC and light transmission control of local region of PDLC, etc.

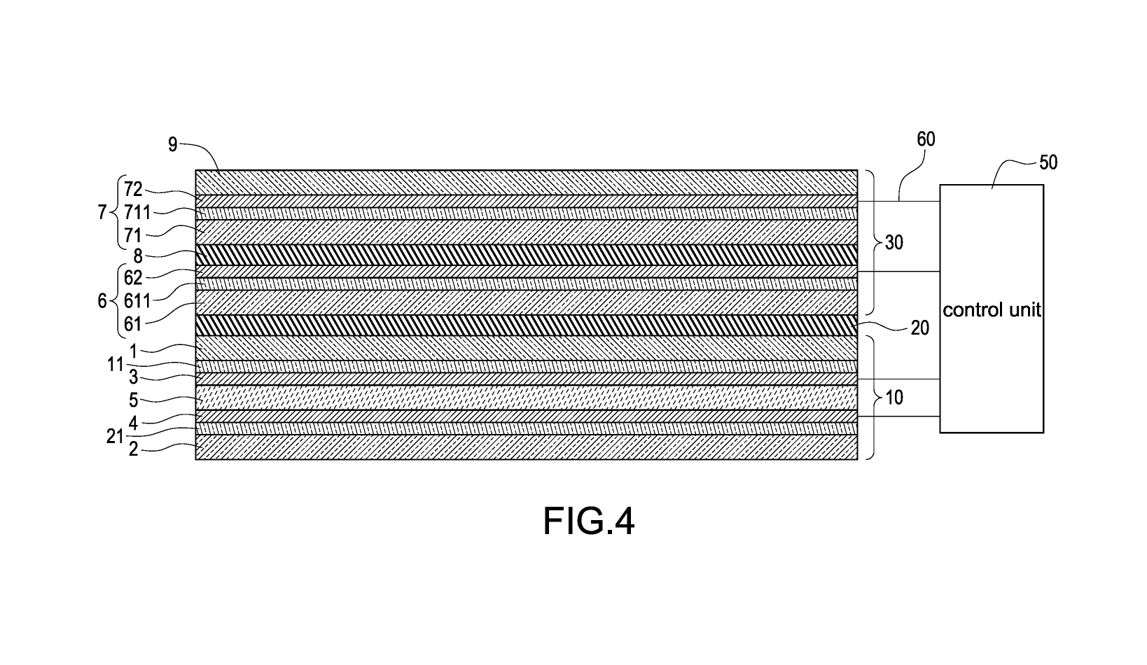

FIG. 4 shows a side view of an optical composite layer structure of a fourth embodiment according to the present invention, wherein the optical composite layer structure connects with an external control unit. According to FIG. 4, in the embodiment, the first and second transparent conductive layers 62, 72 of the touch sensitive composite layer 30 are electrically connected to the control unit 50 by soft cables 60, and the upper and lower transparent conductive layers 3, 4 of the PDLC composite layer 10 are electrically connected to the control unit 50 by soft cables 60. A user can use a capacitive touch sensitive operation of the touch sensitive composite layer 30 to provide a signal instruction to the control unit 50. Accordingly, the corresponding PDLC circuit may drive the corresponding regions of the PDLC composite layer 10 to conduct the change of light transmission of local region, for example hand writing board, the gray level change of light transmission of PDLC and light transmission control of local region of PDLC, etc.

The invention is not limited to these embodiments, but various variations and modifications may be made without departing from the scope of the invention.

What is claimed is:

1. An optical composite layer structure, comprising:
a polymer dispersed liquid crystal composite (PDLC) layer, comprising:
an upper transparent substrate, having an upper curing layer on a side surface thereof;
an upper transparent conductive layer, provided on a side surface of the upper curing layer;
a lower transparent substrate, having a lower curing layer on a side surface of thereof;
a lower transparent conductive layer, provided on a side surface of the lower curing layer; and
a polymer dispersed liquid crystal layer, provided between the upper transparent conductive layer and the lower transparent conductive layer;
a first optical adhesive layer, provided on another side surface of the upper transparent substrate;
a touch sensitive composite layer, provided on a side surface of the first optical adhesive layer, and the touch sensitive composite layer at least including:
a first touch sensitive composite layer, comprising:
a first transparent substrate, having a first curing layer on a side surface of thereof; and
a first transparent conductive layer.

2. The optical composite layer structure according to claim 1, wherein the touch sensitive composite layer further comprises a second optical adhesive layer provided on a side surface of the first transparent conductive layer, and a second touch sensitive composite layer provided on a side surface of the second optical adhesive layer, wherein the second touch sensitive composite layer comprises:
a second transparent substrate, having a second curing layer on a side surface of the second transparent substrate; and
a second transparent conductive layer.

3. The optical composite layer structure according to claim 2, further comprising an optical cover layer provided on a side surface of the second transparent conductive layer.

4. The optical composite layer structure according to claim 2, wherein the upper and lower transparent substrates and the first and second transparent substrates are made of light transmission resins or light transmission glass substrate.

5. The optical composite layer structure according to claim 2, wherein the upper and lower transparent conductive layers and the first and second transparent conductive layers are made of metal or metallic oxides.

6. The optical composite layer structure according to claim 5, wherein the metallic oxides are silver oxide, nano-silver oxide or indium tin oxide (ITO).

7. The optical composite layer structure according to claim 2, wherein the upper and lower transparent conductive layers and the first and second transparent conductive layers are made of organic conductive materials.

8. The optical composite layer structure according to claim 7, wherein the organic conductive materials are carbon nanotube or poly-3,4-ethylenedioxythiophene (PEDOT).

9. The optical composite layer structure according to claim 2, wherein the upper and lower transparent conductive layers and the first and second transparent conductive layers have a thickness in a range of 5 nm-50 um.

10. The optical composite layer structure according to claim 1, wherein the PDLC layer has a thickness in a range of 1 um-100 um.

11. The optical composite layer structure according to claim 1, further comprising a fixed light transmission substrate that is attached with a third optical adhesive layer and a four optical adhesive layer on two side surfaces thereof, and the third optical adhesive layer and the four optical adhesive layer are used for attaching with the PDLC composite layer and the touch sensitive composite layer respectively.

12. The optical composite layer structure according to claim 11, wherein the fixed light transmission substrate is glass window or made of light transmission resins.

13. The optical composite layer structure according to claim 1, further comprising a fifth optical adhesive layer that is provided on another side surface of the upper transparent substrate of the PDLC composite layer, and the fixed light transmission substrate provided on a side surface of the fifth optical adhesive layer.

14. The optical composite layer structure according to claim 2, further comprising soft cables for connecting electrically the upper and lower transparent conductive layers and the first and second transparent conductive layers to a control unit.
